(19) United States
(12) Patent Application Publication
(10) Pub. No.: US 2023/0229474 A1
(43) Pub. Date: Jul. 20, 2023

(54) PLUG-IN MANAGEMENT IN VIRTUALIZED COMPUTING ENVIRONMENT

(71) Applicant: VMware, Inc., Palo Alto, CA (US)

(72) Inventors: Plamen DIMITROV, Sofia (BG); Ankur Kumar SHARMA, Palo Alto, CA (US); Vladimir VELIKOV, Sofia (BG); Hakan HALIL, Sofia (BG); Andrey KARABELYOV, Sofia (BG); Ivaylo RADEV, Sofia (BG); Tony GANCHEV, Sofia (BG)

(73) Assignee: VMware, Inc., Palo Alto, CA (US)

(21) Appl. No.: 17/578,451

(22) Filed: Jan. 19, 2022

(51) Int. Cl. G06F 9/455; G06F 9/445; G06F 21/53; G06F 21/54

(52) U.S. Cl. CPC G06F 9/45558; G06F 9/44526; G06F 21/53; G06F 21/54; G06F 2009/45595; G06F 2009/45587

(57) ABSTRACT

Example methods and systems to register and manage a plug-in in a virtualized computing environment have been disclosed. One example method includes initiating a deployment process to deploy a virtual appliance configured to host the plug-in, pushing information associated with a user interface on a management entity to the virtual appliance to be one or more Open Virtual Appliance (OVA) environment properties, powering on the virtual appliance and registering and managing the plug-in on the management entity through the UI.

### BACKGROUND

Unless otherwise indicated herein, the approaches described in this section are not admitted to be prior art by inclusion in this section.

Virtualization allows the abstraction and pooling of hardware resources to support virtual machines in a virtualized computing environment, such as a Software-Defined Data Center (SDDC). For example, through server virtualization, virtual machines (VMs) running different operating systems may be supported by the same physical machine (e.g., referred to as a “host”). Each VM is generally provisioned with virtual resources to run an operating system and applications. A management entity may be configured to manage these VMs in the virtualized computing environment.

Further, other services may be provided in the virtualized computing environment. For example, when networking services are provided in the virtualized computing environment, logical overlay networks may be provisioned, changed, stored, deleted and restored programmatically without having to reconfigure the underlying physical hardware architecture. For efficiency, there is a need to integrate the management of such services on the management entity.

### BRIEF DESCRIPTION OF DRAWINGS

FIG. 1 is a schematic diagram illustrating an example virtualized computing environment including a management entity configured to register and install a plug-in on the management entity according to one or more embodiments of the present disclosure;

FIG. 2 is a block diagram illustrating an interaction between a management entity configured to register and install a plug-in and a virtual appliance configured to host the plug-in according to one or more embodiments of the present disclosure; and

FIG. 3 is a flow diagram of an example process for a management entity to register and manage a plug-in according to one or more embodiments of the present disclosure.

FIG. 4 illustrates interactions among a plurality of management entities and a virtual appliance in a virtualized computing environment according to one or more embodiments of the present disclosure.

FIG. 5 is a block diagram of an illustrative embodiment of a computer program product for implementing the process of FIG. 3 according to one or more embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. In other embodiments, a first element may be referred to as a second element, and vice versa.

In this disclosure, a “plug-in” refers to a software component that adds a specific feature to an existing computer program. A “virtual appliance” is a pre-configured virtual machine image and ready to run on a virtualization software. A virtual appliance is usually built to host a specific application. An “Open Virtual Appliance (OVA) environment property” may refer to properties (e.g., key/value pairs) that are specified during a deployment of a virtual machine when importing an OVA specification, respectively.

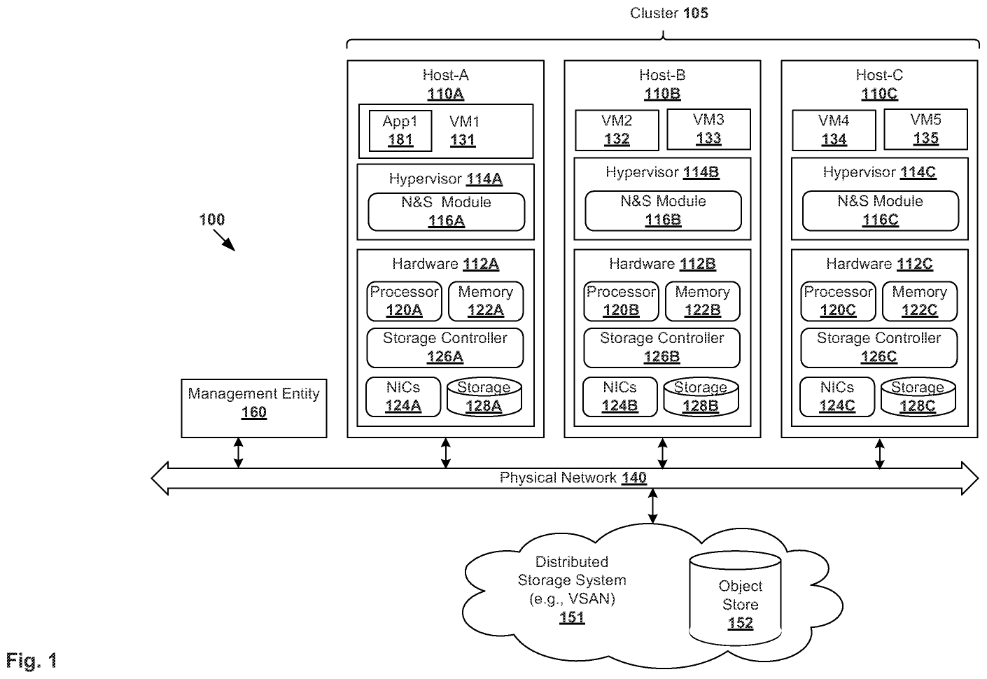

Challenges relating to installation of a plug-in on a management entity in which the plug-in is hosted by a virtual appliance other than the management entity in a virtualized computing environment will now be explained in more detail using FIG. 1, which is a schematic diagram illustrating example virtualized computing environment 100. It should be understood that, depending on the desired implementation, virtualized computing environment 100 may include additional and/or alternative components than that shown in FIG. 1.

In the example in FIG. 1, virtualized computing environment 100 includes cluster 105. Cluster 105 may include one or more hosts. For example, cluster 105 includes host-A 110A, host-B 110B and host-C 110C. In the following, reference numerals with a suffix “A” relates to host-A 110A, suffix “B” relates to host-B 110B, and suffix “C” relates to host-C 110C. Although three hosts (also known as “host computers”, “physical servers”, “server systems”, “host computing systems”, etc.) are shown for simplicity, cluster 105 may include any number of hosts. Although one cluster 105 is shown for simplicity, virtualized computing environment 100 may include any number of clusters.

Each host 110A/110B/110C in cluster 105 includes suitable hardware 112A/112B/112C and executes virtualization software such as hypervisor 114A/114B/114C to maintain a mapping between physical resources and virtual resources assigned to various virtual machines. For example, Host-A 110A supports VM1 131; host-B 110B supports VM2 132 and VM3 133; and host-C 110C supports VM4 134 and VM5 135. In practice, each host 110A/110B/110C may support any number of virtual machines, with each virtual machine executing a guest operating system (OS) and applications. Hypervisor 114A/114B/114C may also be a “type 2” or hosted hypervisor that runs on top of a conventional operating system (not shown) on host 110A/110B/110C.

Although examples of the present disclosure refer to “virtual machines,” it should be understood that a “virtual machine” running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system such as Docker, etc.; or implemented as an operating system level virtualization), virtual private servers, client computers, etc. The virtual machines may also be complete computation environments, containing virtual equivalents of the hardware and software components of a physical computing system.

Hardware 112A/112B/112C includes any suitable components, such as processor 120A/120B/120C (e.g., central processing unit (CPU)); memory 122A/122B/122C (e.g., random access memory); network interface controllers (NICs) 124A/124B/124C to provide network connection; storage controller 126A/126B/126C that provides access to storage resources 128A/128B/128C, etc. Corresponding to hardware 112A/112B/112C, virtual resources assigned to each virtual machine may include virtual CPU, virtual memory, virtual machine disk(s), virtual NIC(s), etc.

Storage controller 126A/126B/126C may be any suitable controller, such as redundant array of independent disks (RAID) controller, etc. Storage resource 128A/128B/128C may represent one or more disk groups. In practice, each disk group represents a management construct that combines one or more physical disks, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, Integrated Drive Electronics (IDE) disks, Universal Serial Bus (USB) storage, etc.

Through storage virtualization, hosts 110A/110B/110C in cluster 105 aggregate their storage resources 128A/128B/128C to form distributed storage system 151, which represents a shared pool of storage resources. For example, in FIG. 1, hosts 110A/110B/110 aggregate respective local physical storage resources 128A/128B/128C into object store 152. Data stored in object store 152 may be placed on, and accessed from, one or more of storage resources 128A/128B/128C. In practice, distributed storage system 151 may employ any suitable technology, such as Virtual Storage Area Network (vSAN) from VMware, Inc.

In virtualized computing environment 100, management entity 160 provides management functionalities to various managed objects, such as cluster 105, hosts 110A-110C, virtual machines 131-135, etc. Management entity 160 may include a management application (e.g., VMware vSphere®, VMware vCenter Server®, etc.) having a first user interface (UI) to manage these objects, such as cluster 105, hosts 110A-110C, virtual machines 131-135 in virtualized computing environment 100.

Management entity 160 may be configured to deploy virtual machines 131-135 in virtualized computing environment 100. VM1 131 may include another management application to provide a centralized management plane for an additional feature (e.g., network virtualization or storage virtualization) in virtualized computing environment 100 that the management application on management entity 160 did not provide. App1 181 running on VM1 131 may be a plug-in to facilitate the centralized management plane. For example, App1 181 may be VMware NSX® Manager™, a second party application or a third party application. App1 181 may provide a second UI and REST APIs for managing (e.g., creating, configuring, and/or monitoring) networking and security components in virtualized computing environment 100, such as distributed networking and security (N&S) modules 116A/116B/116C on hosts 110A/110B/110C, controllers, logical switches, and edge services gateways.

Conventionally, after App1 181 is installed on VM1 131, VM1 131 may be registered with management entity 160 through the second UI. By registering and connecting to management entity 160, VM1 131 running App1 181 may display infrastructure inventory (e.g., cluster 105, hosts 110A-110C, virtual machines 131-135) which allows managements of the additional feature (e.g., network virtualization or storage virtualization) associated with the infrastructure inventory through the second UI of App1 181.

However, there are various shortcomings in the conventional approach. For example, a user needs to deploy VM1 131 through the first UI on management entity 160 first, install App1 181 through the second UI on VM1 131 and register App1 181 running on VM1 131 with management entity 160 through the second UI later. The user needs to switch between the first UI and the second UI. In addition, in registering and connecting to management entity 160, the user may need to input an address associated with management entity 160 and a username and a password to log in management 160 through the second UI. Along the complex and numerous steps above, user's experiences may be damaged.

In some embodiments, management entity 160 may register and install the plug-in through the first UI alone, instead of through the first UI and the second UI, to address the shortcomings described above.

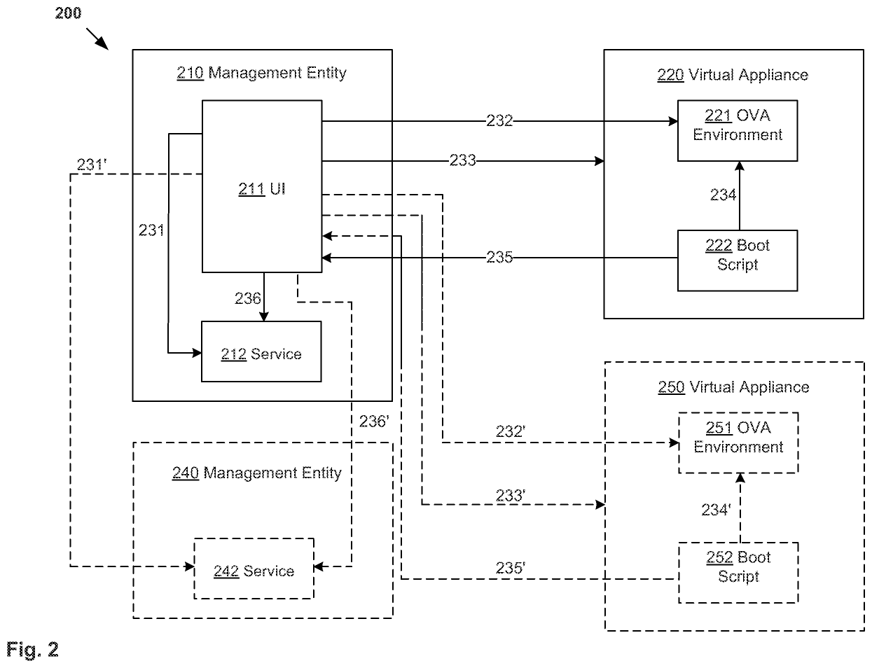

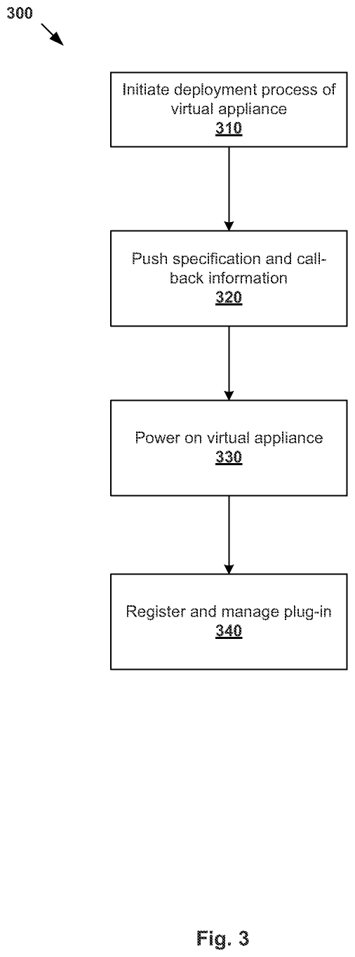

FIG. 2 illustrates interactions between management entity 210 and virtual appliance 220 in virtualized computing environment 200, according to one or more embodiments of the present disclosure. Management entity 210 is configured to register and install a plug-in, and virtual appliance 220 is configured to host the plug-in. In some embodiments, management entity 210 corresponds to management entity 160 of FIG. 1, and virtual appliance 220 corresponds to VM1 131 of FIG. 1. The interactions between management entity 210 and virtual appliance 220 may include actions 231, 232, 233, 234, 235 and 236. These actions are further explained in conjunction with FIG. 3 in the following paragraphs.

FIG. 3 is a flow diagram of an example process 300 for a management entity to install, register and manage an application with a plug-in associated with the application, according to one or more embodiments of the present disclosure. Process 300 may include one or more operations, functions, or actions illustrated by one or more blocks, such as 310 to 340. The various blocks may be combined into fewer blocks, divided into additional blocks, and/or eliminated depending on the desired implementation. In some embodiments, process 300 may be performed by management entity 160 illustrated in FIG. 1.

Process 300 may start with block 310 “initiate deployment process of virtual appliance.” In some embodiments, in conjunction with FIG. 2, block 310 may correspond to action 231. In action 231, a user may initiate a deployment process of a virtual appliance through UI 211 on management entity 210. Based on the information received by UI 211, management entity 210 may generate an Open Virtual Appliance (OVA) specification associated with the virtual appliance and direct the OVA specification to service 212. Service 212 may include, but not limited to, an OVA service to process the OVA specification and a registration service to register a plug-in with management entity 210. The OVA specification includes, but not limited to, a pre-configured VM image and an installation package of the plug-in including a uniform resource locator (URL) associated with the plug-in. In some embodiments, UI 211 may correspond to the first UI on management entity 160 of FIG. 1. Block 310 may be followed by block 320.

In some embodiments, in conjunction with FIG. 2, block 320 “push specification and call-back information” may correspond to action 232. In action 232, management entity 210 is first configured to push information included in the OVA specification to virtual appliance 220 during the deployment of virtual appliance 220. In addition, after virtual appliance 220 is deployed, management entity 210 is then configured to push call-back information to OVA environment 221 as OVA environment properties of virtual appliance 220. In some embodiments, the call-back information includes, but not limited to, UI endpoint information associated with UI 211, UI thumbprint information associated with UI 211 and a security token. The UI endpoint information is configured to allow virtual appliance 220 calling back to an Application Program Interface (API) of UI 211 on management entity 210 and request for registering the plug-in. The UI thumbprint information is configured to establish a secure connection between virtual appliance 220 and management entity 210. The security token is configured to allow UI 211 to set up a trust connection with the particular virtual appliance 220 and to verify one or more requests for registering the same plug-in discussed in actions 231 and 232. Block 320 may be followed by block 330.

In some embodiments, in conjunction with FIG. 2, block 330 “power on virtual appliance” may correspond to action 233. In action 233, virtual appliance 220 is configured to be powered on for the first time. The power on of the virtual appliance may be followed by actions 234 and 235 performed by virtual appliance 220.

In some embodiments, action 233 may be followed by action 234. In action 234, in response to the power on of virtual appliance 220, OVA environment 221 will be read based on boot script 222 of virtual appliance 220. Therefore, OVA environment properties, including information included in the OVA specification and the call-back information, in OVA environment 221 will also be read in response to virtual appliance 220 being powered on for the first time. Action 234 may be followed by action 235.

In some embodiments, in action 235, virtual appliance 220 is configured to call back an API of UI 211 on management entity 210 based on the UI endpoint information transmitted in action 232 and establish a secure connection with management entity 210 based on the UI thumbprint transmitted in action 232. Virtual appliance 220 is also configured to transmit details of the plug-in (e.g., the URL associated with the plug-in and the UI thumbprint information) based on information included in the OVA specification and the call-back information. In addition, virtual appliance 220 is configured to request for registering the plug-in with UI 211. On the other hand, management entity 210 is configured to receive a request of calling back from virtual appliance 220 for UI 211 to establish a secure connection and register the plug-in with management entity 210. Management entity 210 is also configured to receive details of the plug-in as a payload of the request through the secure connection between management entity 210 and virtual appliance 220.

In some embodiments, referring back to FIG. 3, Block 330 may be followed by block 340 “register and manage plug-in.” In some embodiments, in conjunction with FIG. 2, block 340 may correspond to action 236 which follows action 235. In some embodiments, in action 236, UI 211 is configured to register the plug-in on management entity 210. In some embodiments, after the plug-in is registered, the plug-in is managed by a plug-in manager on UI 211. The plug-in manager may allow management entity 210 to download and install the plug-in through UI 211.

Compared to conventional approach, in some embodiments, the plug-in can be managed and installed through UI 211 alone, instead of through any UIs on virtual appliance 220.

In some embodiments, virtualized computing environment 200 may include another management entity (e.g., management entity 240) other than management entity 210 and another virtual appliance (e.g., virtual appliance 250) other than virtual appliance 220. Management entity 240 may support service 242 similar to service 212 in management entity 210. Virtual appliance 250 may have OVA environment 251 and boot script 252 similar to OVA environment 221 and boot script 222 in virtual appliance 220. In some embodiments, UI 211 may select to perform action 231′ (similar to action 231 discussed above) through service 242 in management entity 240 to deploy virtual appliance 250, action 232′ (similar to action 232 discussed above) to push information included in the OVA specification to virtual appliance 250 during the deployment of virtual appliance 250 and call-back information to OVA environment 251 as OVA environment properties of virtual appliance 250 after virtual appliance 250 is deployed and action 233′ (similar to action 233 discussed above) to power on virtual appliance 250. The power on of virtual appliance 250 may be followed by actions 234′ (similar to action 234 discussed above) and 235′ (similar to action 235 discussed above) performed by virtual appliance 250.

After virtual appliance 250 performs actions 234′ and 235′, UI 211 may receive a request from virtual appliance 250 to establish a secure connection and register the plug-in with management entity 210, and details of the plug-in through the secure connection between management entity 210 and virtual appliance 250. UI 211 is also configured to perform action 236′ (similar to action 236 discussed above) through service 242. Therefore, UI 211 is configured to register the plug-in on management entity 240. In some embodiments, after the plug-in is registered, the plug-in is managed by a plug-in manager on UI 211. The plug-in manager may allow management entity 240 to download and install the plug-in through UI 211.

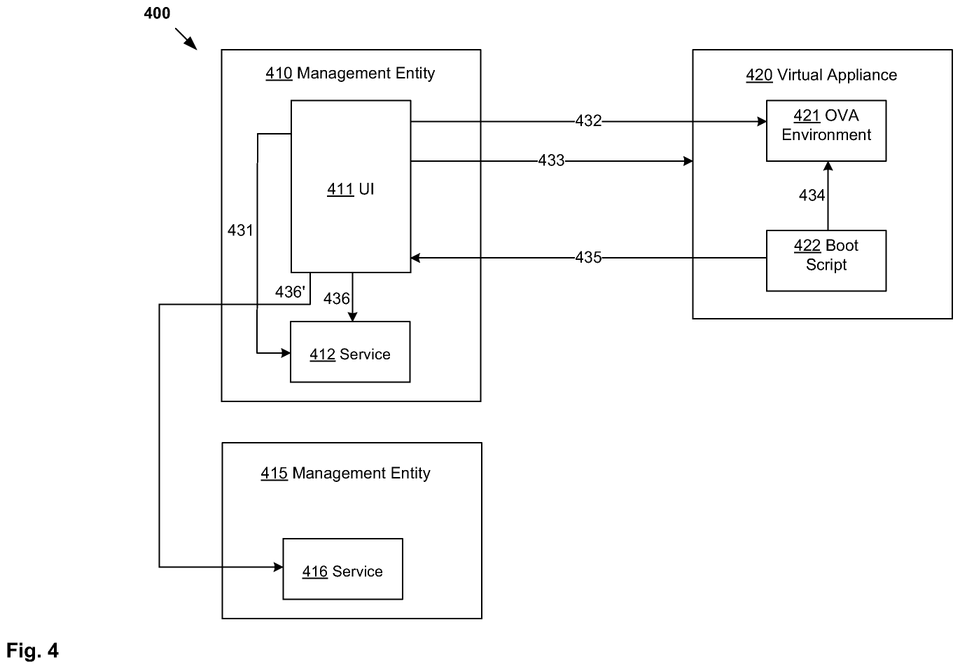

FIG. 4 illustrates interactions among a plurality of management entities 410/415 and virtual appliance 420 in virtualized computing environment 400, according to one or more embodiments of the present disclosure. Management entity 410 and management entity 415 are configured to register and install a plug-in, and virtual appliance 420 is configured to host the plug-in. In some embodiments, in conjunction with FIG. 2, management entity 410 corresponds to management entity 210 and includes UI 411 corresponding to UI 211 and service 412 corresponding to service 212. Management entity 415 may include service 416 similar to service 412. Virtual appliance 420 may have OVA environment 421 and boot script 422 similar to OVA environment 221 and boot script 222 in virtual appliance 220.

In some embodiments, UI 411 may select to perform action 431 (similar to action 231 discussed above) through service 412 in management entity 410 to deploy virtual appliance 420, action 432 (similar to action 232 discussed above) to push information included in the OVA specification to virtual appliance 420 during the deployment of virtual appliance 420 and call-back information to OVA environment 421 as OVA environment properties of virtual appliance 420 after virtual appliance 520 is deployed and action 433 (similar to action 233 discussed above) to power on virtual appliance 420. The power on of virtual appliance 420 may be followed by actions 434 (similar to action 234 discussed above) and 435 (similar to action 235 discussed above) performed by virtual appliance 420.

After virtual appliance 420 performs actions 434 and 435, UI 411 may receive a request from virtual appliance 420 to establish a secure connection and register a plug-in with management entity 410, and details of the plug-in through the secure connection between management entity 410 and virtual appliance 420. UI 411 is also configured to perform action 436 (similar to action 236 discussed above) through service 412 to register the plug-in on management entity 410 and action 436′ (similar to action 236′ discussed above) through service 416 to register the plug-in on management entity 415. In some embodiments, after the plug-in is registered, the plug-in is managed by a plug-in manager on UI 411. The plug-in manager may allow UI 411 to download and install the plug-in from management entities 410 and 415.

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc.

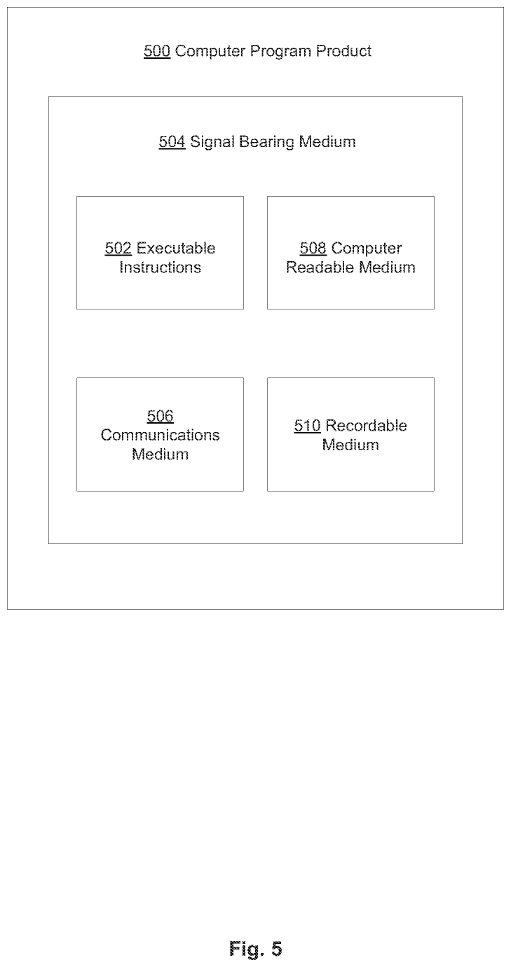

FIG. 5 is a block diagram of an illustrative embodiment of a computer program product 500 for implementing process 300 of FIG. 3, according to one or more embodiments of the present disclosure. Computer program product 500 may include a signal bearing medium 504. Signal bearing medium 504 may include one or more sets of executable instructions 502 that, in response to execution by, for example, one or more processors of management entity 160 of FIG. 1, may provide at least the functionality described above with respect to FIGS. 1-3.

In some implementations, signal bearing medium 504 may encompass a non-transitory computer readable medium 508, such as, but not limited to, a solid-state drive, a hard disk drive, a Compact Disc (CD), a Digital Video Disk (DVD), a digital tape, memory, etc. In some implementations, signal bearing medium 504 may encompass a recordable medium 510, such as, but not limited to, memory, read/write (R/W) CDs, R/W DVDs, etc. In some implementations, signal bearing medium 504 may encompass a communications medium 506, such as, but not limited to, a digital and/or an analog communication medium (e.g., a fiber optic cable, a waveguide, a wired communications link, a wireless communication link, etc.). Computer program product 500 may be recorded on non-transitory computer readable medium 508 or another similar recordable medium 510.

A “computer readable medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.).

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array, etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for a management entity to register and manage a plug-in in a virtualized computing environment, comprising:
initiating a deployment process to deploy a virtual appliance configured to host the plug-in;
pushing information associated with a user interface (UI) on the management entity to the virtual appliance to be one or more Open Virtual Appliance (OVA) environment properties;
powering on the virtual appliance; and
registering and managing the plug-in on the management entity through the UI.

2. The method of claim 1, wherein initiating the deployment process further includes generating an OVA specification including a pre-configured virtual machine image and an installation package of the plug-in having a uniform resource locator (URL) associated with the plug-in and sending the OVA specification to a service running on the management entity.

3. The method of claim 1, wherein pushing information associated with the UI further comprises pushing endpoint information associated with the UI, thumbprint information associated with the UI and a security token to the OVA environment of the virtual appliance.

4. The method of claim 3, after powering on the virtual appliance, further comprising receiving a call back request associated with the UI based on the endpoint information to establish a secure connection between the management entity and the virtual appliance based on the thumbprint information and the security token.

5. The method of claim 4, further comprising receiving installation information including the URL from the virtual appliance through the secure connection.

6. The method of claim 5, wherein registering and managing the plug-in further includes installing the plug-in based on the received URL through the UI.

7. The method of claim 1, further comprising registering the plug-in on another management entity and managing the plug-in registered with the another management entity through the UI.

8. A non-transitory computer-readable storage medium that includes a set of instructions which, in response to execution by a processor of a computer system, cause the processor to perform method for a management entity to register and manage a plug-in in a virtualized computing environment, the method comprising:
initiating a deployment process to deploy a virtual appliance configured to host the plug-in;
pushing information associated with a user interface (UI) on the management entity to the virtual appliance to be one or more Open Virtual Appliance (OVA) environment properties;
powering on the virtual appliance; and
registering and managing the plug-in on the management entity through the UI.

9. The non-transitory computer-readable storage medium of claim 8, wherein initiating the deployment process further includes generating an OVA specification including a pre-configured virtual machine image and an installation package of the plug-in having a URL associated with the plug-in and sending the OVA specification to a service running on the management entity.

10. The non-transitory computer-readable storage medium of claim 8, wherein pushing information associated with the UI further comprises pushing endpoint information associated with the UI, thumbprint information associated with the UI and a security token to the OVA environment of the virtual appliance.

11. The non-transitory computer-readable storage medium of claim 10, after powering on the virtual appliance, the method further comprising receiving a call back request associated with the UI based on the endpoint information to establish a secure connection between the management entity and the virtual appliance based on the thumbprint information and the security token.

12. The non-transitory computer-readable storage medium of claim 11, the method further comprising receiving installation information including the URL from the virtual appliance through the secure connection.

13. The non-transitory computer-readable storage medium of claim 12, wherein registering and managing the plug-in further includes installing the plug-in based on the received URL through the UI.

14. The non-transitory computer-readable storage medium of claim 8, further comprising registering the plug-in on another management entity and managing the plug-in registered with the another management entity through the UI.

15. A computer system configured to register and manage a plug-in in a virtualized computing environment, comprising:
a processor; and
a non-transitory computer-readable medium having stored thereon instructions that, in response to execution by the processor, cause the processor to:
initiate a deployment process to deploy a virtual appliance configured to host the plug-in;
push information associated with a user interface (UI) on the management entity to the virtual appliance to be one or more Open Virtual Appliance (OVA) environment properties;
power on the virtual appliance; and
register and manage the plug-in on the management entity through the UI.

16. The computer system of claim 15, wherein the non-transitory computer-readable medium has stored thereon additional instructions that, when executed by the processor, cause the processor to generate an OVA specification including a pre-configured virtual machine image and an installation package of the plug-in having a URL associated with the plug-in and send the OVA specification to a service running on the management entity.

17. The computer system of claim 15, wherein the non-transitory computer-readable medium has stored thereon additional instructions that, when executed by the processor, cause the processor to push endpoint information associated with the UI, thumbprint information associated with the UI and a security token to the OVA environment of the virtual appliance.

18. The computer system of claim 17, wherein the non-transitory computer-readable medium has stored thereon additional instructions that, when executed by the processor, cause the processor to receive a call back request associated with the UI based on the endpoint information to establish a secure connection between the management entity and the virtual appliance based on the thumbprint information and the secure token.

19. The computer system of claim 18, wherein the non-transitory computer-readable medium has stored thereon additional instructions that, when executed by the processor, cause the processor to receive the installation information including the URL from the virtual appliance through the secure connection.

20. The computer system of claim 19, wherein the non-transitory computer-readable medium has stored thereon additional instructions that, when executed by the processor, cause the processor to install the plug-in based on the received URL through the UI.

21. The computer system of claim 15, wherein the non-transitory computer-readable medium has stored thereon additional instructions that, when executed by the processor, cause the processor to register the plug-in on another management entity and manage the plug-in registered with the another management entity through the UI.
